(19) United States
(12) Patent Application Publication
(10) Pub. No.: US 2023/0007005 A1
(43) Pub. Date: Jan. 5, 2023

(54) SYSTEMS AND METHODS FOR ANONYMOUS PASS-PHRASE AUTHENTICATION

(71) Applicant: VERIZON PATENT AND LICENSING INC., Basking Ridge, NJ (US)

(72) Inventor: Rahul KONERU, Ashburn, VA (US)

(73) Assignee: VERIZON PATENT AND LICENSING INC., Basking Ridge, NJ (US)

(21) Appl. No.: 17/366,209

(22) Filed: Jul. 2, 2021

(51) Int. Cl. H04L 29/06

(52) U.S. Cl. CPC H04L 63/102; H04L 63/0815; H04L 63/0272; H04L 63/0421; H04L 2463/082

(57) ABSTRACT

Disclosed are systems and methods for anonymous, hands-free voice authentication to network resources. The framework can operate and provide a secure authenticated operating environment for any type of computerized platform, device and/or service while preserving anonymity of both the user and the user's login credentials. Once authenticated, the user is then permitted to perform desired operations, such as, CRUD (create, read, update, delete) operations. The disclosed framework operates in a three stage process, which involves single-sign on (SSO)/virtual private network (VPN) connectivity, which is then followed by a 4way voice matching user-device integrated “conversation” and a proof of work macro-micro problem verification step. The framework enables a user to login and access a system by responding to randomly verifiable requests output by the system dependent on the user's current surroundings.

### BACKGROUND INFORMATION

Electronic devices house and enable access to sensitive and securely held data. This data, for example, can include personally identifiable data (PID) of a user that can be located on the user's device or accessible via the device's secure connections to network resources. The data can also include, but is not limited to, privileged, privately held and/or classified information related to the resources the device is accessing, which can relate to other users and/or the applications or enterprises hosting and/or facilitating access to such resources.

### BRIEF DESCRIPTION OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram illustrating an example of a network configuration within which the systems and methods disclosed herein could be implemented according to some embodiments of the present disclosure;

FIG. 2 depicts a non-limiting example embodiment of authentication engine 200 according to some embodiments of the present disclosure;

FIG. 3 illustrates a non-limiting example of a work flow performed by authentication engine 200 according to some embodiments of the present disclosure;

FIG. 4 illustrates a non-limiting example of audible information matching performed by authentication engine 200 according to some embodiments of the present disclosure;

FIG. 5 is a block diagram of an example network architecture according to some embodiments of the present disclosure; and

FIG. 6 is a block diagram illustrating a computing device used in various embodiments of the present disclosure.

### DETAILED DESCRIPTION OF EXAMPLE EMBODIMENTS

The disclosed systems and methods provide a novel framework for anonymous authentication. The framework can provide a secure authenticated operating environment for any type of computerized platform, device and/or service. For example, the framework can enable authenticated sessions for users in and/or on, but not limited to, artificial intelligence (AI) chat bots, web-portals, voice enabled mobile devices, internet-of-things (IoT) devices, smart cars, drones and any other type of smart device (e.g., smart speakers, smart digital assistants and voice enabled virtual assistants powered by AI technology), and the like.

The disclosed framework provides systems and methods that enable user authentication while preserving anonymity of both the user and the login credentials (e.g., username, password, biometrics, PINs, and the like) that are used. Once authenticated, the user is then permitted to perform desired operations such as, but not limited to, CRUD (create, read, update, delete) operations on an enterprise system or an IoT device, for example.

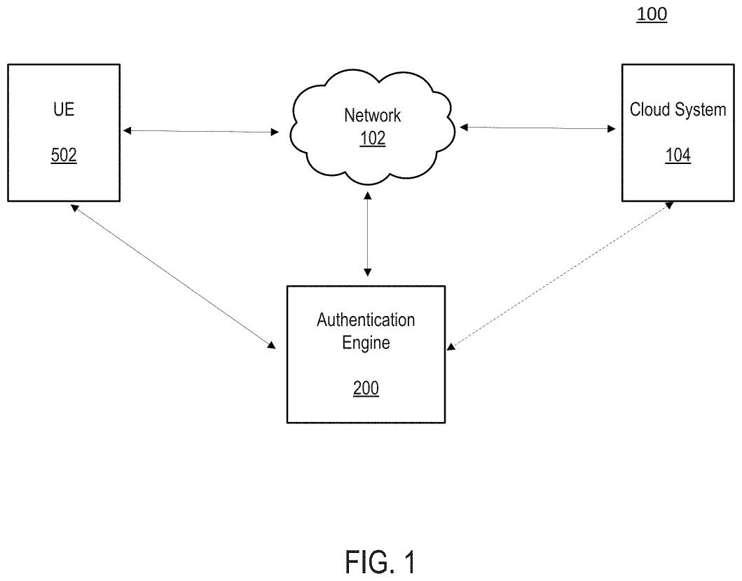

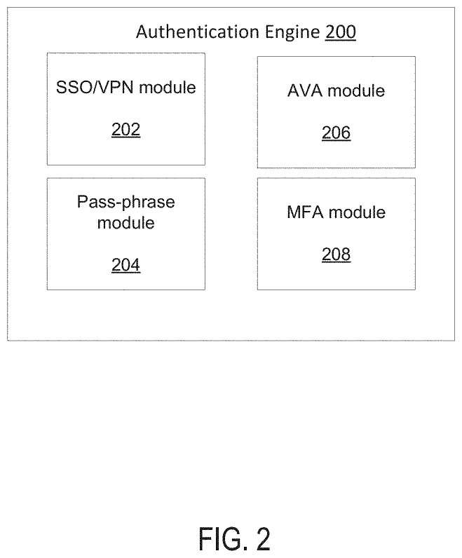

According to some embodiments, the framework operates in a three-stage process. The Stages include 1) a single sign-on (SSO) and virtual private network (VPN) stage; 2) a “4way” match stage; and 3) a validation stage. In some embodiments, as discussed below, the framework can be executed by an authentication engine 200 (of FIG. 2), whereby Stage 1 can be executed by SSO/VPN module 202, Stage 2 by pass-phrase module 204, and Stage 3 by Anonymous Voice Authentication (AVA) module 206. In some embodiments, as discussed below, Stage 3 (and in some embodiments, Stage 2) may additionally involve execution of the multi-factor authentication (MFA) module 208. Configurations, operating environments and network integration of engine 200 are depicted in FIGS. 1-2, and discussed below in more detail.

According to some embodiments, the framework can involve operations performed on a user's device that enable authentication of the user's identity. In some embodiments, each of the three-stages can be executed by engine 200 operating on the user's device. In some embodiments, the framework can be configured as a web-based application or executable file (or extension) that a user device accesses over a network in order for each (or at least a portion of) the three-stages to be performed. In some embodiments, the framework (e.g., engine 200) can be hosted by a network resource (e.g., a server) that provides networked authentication capabilities.

As discussed in more detail below, Stage 1, the initial stage, is where a user provides SSO credentials to establish a VPN connection in order to begin the authentication processing discussed herein. In some embodiments, the SSO/VPN stage occurs at the device level. For example, the user can “login” or gain access to his/her device, whereby Stage 1 is presumed cleared and processing proceeds to Stage 2.

In some embodiments, Stage 2 involves 4way matching where voice pass-phrases are matched and authenticated. In some embodiments, a sequential combination of a predetermined number of alternating spoken and audibly output pass-phrases (or keys or terms, used interchangeably) are utilized to confirm the user's “proof of identity” (POI), i.e., they “are who they are representing they are.” As discussed below, the pass-phrases can be predefined and according to an order that must be spoken by the user and/or provided by the framework in order for POI to be confirmed.

In some embodiments, as discussed herein, 4 pass-phrases can be utilized, but this should not be construed as limiting, as a variation of the number of exchanged phrases can also and/or alternatively be utilized, depending on an operating environment of the user, and/or user, device, application, resource and/or framework preferences.

As discussed in more detail below according to some embodiments, 4way matching involves the interplay between spoken terms by a user and audibly output terms by an AI model's natural language processing (NLP) layer of the framework and/or of a service provider (e.g., Alexa® from Amazon® or Siri® from Apple®, for example). 4way matching includes an initial phrase being spoken by the user (referred to as an “invocation word”), whereby the framework audibly responds with its counterpart, then the framework audibly outputs another phrase which has its own counterpart term that the user must provide, for example by speaking it (referred to as a “closing word”).

According to embodiments of the instant disclosure, the invocation word provided (or input) by the user provides an indication as to the type of “scene” the user is operating in. That is, according to some embodiments, the disclosed framework is adaptable for operating in different types of real-world and/or digital environments (e.g., referred to as “scenes” as discussed in more detail below). In some embodiments, three types of scenes can exist: public, semi-public and private.

In some embodiments, a public scene refers to situations where a user is attempting to login to a secure resource while in public (e.g., at the airport, at the mall, or any other location where there is a majority of strangers in a proximity that could adversely hear and/or obtain login credentials). In some embodiments, a semi-public scene refers to a family setting, or a setting where a user is physically located proximate to friends, family and/or other acquaintances where the risk of the user's credentials being pirated are relatively low (e.g., driving in a car with a family member or friend, or having dinner at home with a guest). In some embodiments, a private scene refers to a setting where no-one else is remotely around (e.g., driving in a car solo, being at home alone, being in an office alone, and the like). In exemplary embodiments, scenes may be configurable by users.

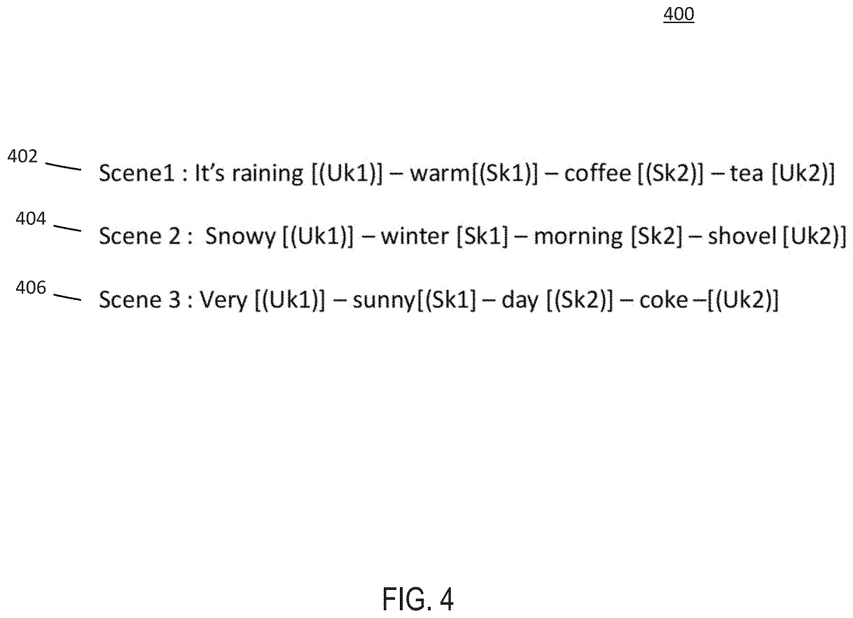

Therefore, for example, according to some embodiments as illustrated in FIG. 4, item 402 (and discussed in more detail below), after passing Stage 1 (e.g., gaining access to his/her device), the user is prompted and speaks the phrase “It's raining”. This indicates to the framework that the user is in “Scene 1” (e.g., a public scene, for example). In response, the framework audibly outputs “warm”; the framework then audibly outputs “coffee”, whereby the proper response (e.g., closing word) to be spoken by the user is “tea.” This “request-receive” back-and-forth exchange between the user and the framework confirms POI for the user and enables processing to proceed to Stage 3. Moreover, the processing of Stage 2 ensures that the application system the user is intending to interact with is the same system he/she is interacting with.

It should be understood that while the discussion herein focuses on words or phrases being spoken or otherwise output to the user, it should not be construed as limiting, as any other type of information can be audibly or otherwise received and/or output to the user or entered by the user (e.g., numbers, sounds, shapes, haptic effects and the like) without departing from the scope of the instant disclosure.

Once the Stage 2 is concluded (e.g., the user provides the proper closing word), Stage 3 is triggered, which involves validation of the user's “proof of work” (POW) via an Anonymous Voice Authentication (AVA) model (e.g., AVA module 206 of authentication engine 200, as discussed below).

According to some embodiments, the AVA model can include a series or set of mathematical, binary and/or alpha (macro) patterns. The patterns can be predefined and/or preselected by a user, and in some embodiments, can be stored in designated AVA configuration tables associated with and/or accessible by an application or portal, and engine 200.

Each macro pattern corresponds to a type of scene. In some embodiments, a scene can be mapped to a number of micro patters to ensure anonymity and to avoid any risk of potential pattern decoding by intruders. For example, as discussed in more detail below, a simple mathematical POW pattern can correspond to a private scene, whereas a complex binary POW pattern can corresponds to a public scene.

Each macro pattern includes a set of micro patterns that engine 200 can randomly select for solving by the user, as discussed below. For example, as discussed below, mathematical micro patterns can include, but are not limited to, index based additions, subtractions, multiplications, squares, exponents, simple equations and the like. Examples of binary micro patterns can include, but are not limited to, adding, multiplying and dividing binary numbers, and the like. Examples of alpha micro patterns can include, but are not limited to, string shifting and string substitutions, and the like. These patterns represent POW problems that the user must solve (or provide the correct solution or response to) in order for the user's POW to be validated.

According to some embodiments, each micro pattern has a predefined manipulation or calculation associated with it. For example, if the micro pattern is for addition, the user can set a value of 2; therefore, when presented with a number “10”, for example, the user's addition of “2” resulting in “12” provides a correct answer thereby confirming the user's POW. In some embodiments, the manipulation or calculation can be set by the user, as mentioned above. Therefore, when a user is presented with a micro pattern, how it is solved can be anticipated despite the micro pattern being randomly selected by engine 200.

By way of a non-limiting example, a POW problem pattern can provide the user with a set of decimal numbers whereby the user is expected to perform decimal addition of a decimal value. In another example, a binary value can be provided whereby binary multiplication is expected/request. Examples of an addition pattern are provided in the below table:

TABLE 1

| | Binary | Decimal |
|---|---|---|
| Random AVA input: | 1010 | 10 |
| Value to be added: | 0011 | 3 |
| Expected user input: | 1101 | 13 |

Table 1 provides “Random AVA input” which is the randomly selected micro pattern for binary and decimal macro patterns. “Value to be added” corresponds to the predetermined manipulation/calculation value set by the user; and “expected user input” corresponds to the correct answer engine 200 expects to receive in order to confirm POW.

In Table 1's example, the AVA model can output the binary value of 1010, and the user is expected to provide the value resulting from the addition of binary 0011. Similarly, the AVA model can provide the decimal value of 10, whereby the user is expected to provide the solution resultant from adding decimal 3. As mentioned above, in some embodiments, the value being added is the value the user predetermines, thereby a random value being provided by the AVA model can be used for POW since the expected result/solution provided by the user can be checked/confirmed against the user's predetermined value being received. In some embodiments, for any input generated randomly by the AVA model, there may be 1 or more acceptable POW values, as the user can apply 1 or more micro patterns and all the valid responses will be computed and accepted by the AVA model.

In another example, a POW problem pattern can involve an alpha pattern shift of places. For example, as illustrated in the below table:

TABLE 2

| | Alpha Pattern |
|---|---|
| Random AVA input: | ACB |
| Value to be added: | 222 |
| Expected user input: | CED |

Table 2 provides “Random AVA input” which is the randomly selected micro pattern for alpha patterns. “Value to be added” corresponds to the predetermined manipulation set by the user; and “expected user input” corresponds to the correct alpha-shifting engine 200 expects to receive in order to confirm POW.

In Table 2's example, the AVA model randomly provided the user with the character string “ACB”. It is expected (from, for example, the user's predefined setting) that the output will shift each character in the 3 character string 2 places—“222”. That is, for example the user can predefine that when presented with a 3 character string, each character will shift 2 places (e.g., 222). In some embodiments, a user setting can indicate any length of string is to be shifted n places. Therefore, in this example, the correct alpha-shifting of the “ACB” input is “CED”, where the “A” shifts 2 characters to the “C”, the “C” shifts 2 characters to the “E”, and the “B” shifts 2 characters to the “D”. Another non-limiting example can be scrambling or swapping 1 or more positions of the string of characters or numbers.

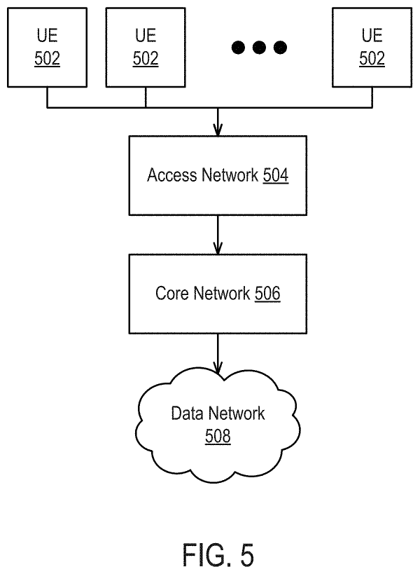

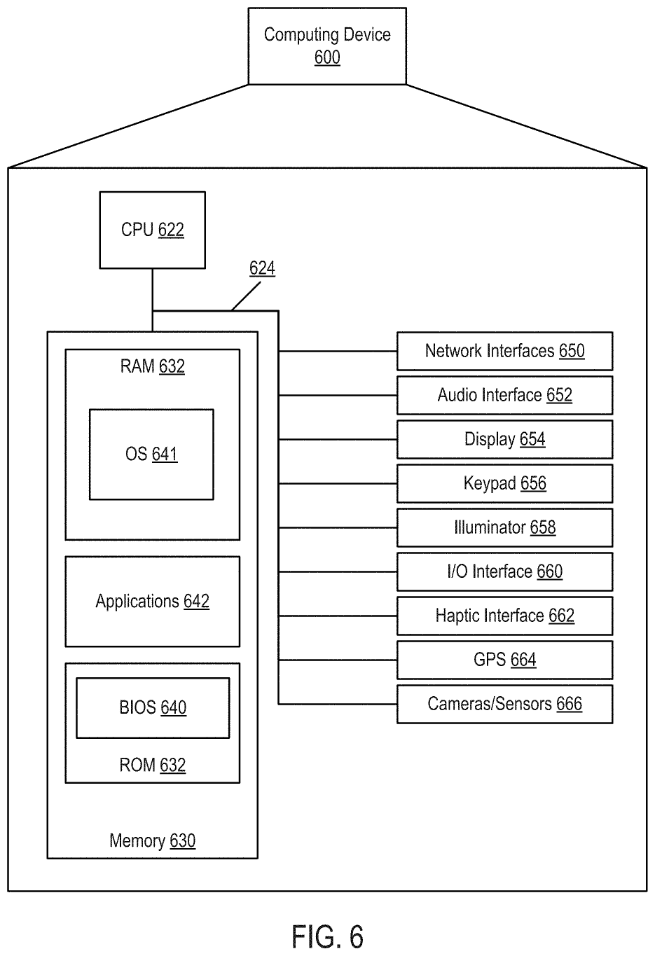

With reference to FIG. 1, system 100 is depicted which includes user equipment (UE) 502, network 102, cloud system 104 and authentication engine 200. UE 502 can be any type of device, such as, but not limited to, a mobile phone, tablet, laptop, sensor, IoT device, autonomous machine, and any other device equipped with a cellular or wireless or wired transceiver. Further discussion of UE 502 is provided below in reference to FIGS. 5-6.

Network 102 can be any type of network, such as, but not limited to, a wireless network, cellular network, the Internet, and the like. Network 102 facilitates connectivity of the components of system 100, as illustrated in FIG. 1. A further discussion of the network configuration and type of network is provided below in reference to FIG. 5.

Cloud system 104 can be any type of cloud operating platform and/or network based system upon which operations, applications, and/or other forms of network resources can be located. For example, system 104 can be a third party service provider and/or network provider. In some embodiments, cloud system 104 can include a server(s) and/or a database of information which is accessible over network 102, whereby such access is granted via the authentication processing discussed herein. In some embodiments, a database (not shown) of cloud system 104 can store a dataset of data and metadata associated with local and/or network information related to a user(s) of UE 502 and the UE 502, and the services, applications, content rendered and/or executed by UE 502.

In some embodiments, as discussed above and in more detail below, system 104 can provide AI NLP (e.g., host or provide access to the NLP layer) upon which AVA processing is performed. In some embodiments, system 104 can integrate and/or connect with another cloud or network-based system that provides AI NLP for AVA processing, as discussed below.

Authentication engine 200, as discussed above, includes components for performing the 3 Stage authentication processing discussed herein. Authentication engine 200 can be a special purpose machine or processor and could be hosted by UE 502. In some embodiments, engine 200 can be hosted by a peripheral device connected to UE 502.

According to some embodiments, as discussed above, engine 200 can function as an application installed on UE 502. In some embodiments, such application can be a web-based application accessed by UE 502 over network 102 (e.g., as indicated by the connection between network 102 and engine 200, and/or the dashed line between cloud system 104 and engine 200 in FIG. 1). In some embodiments, engine 200 can be configured and/or installed as an augmenting script, program or application (e.g., a plug-in or extension) to another application and/or AI/ML model.

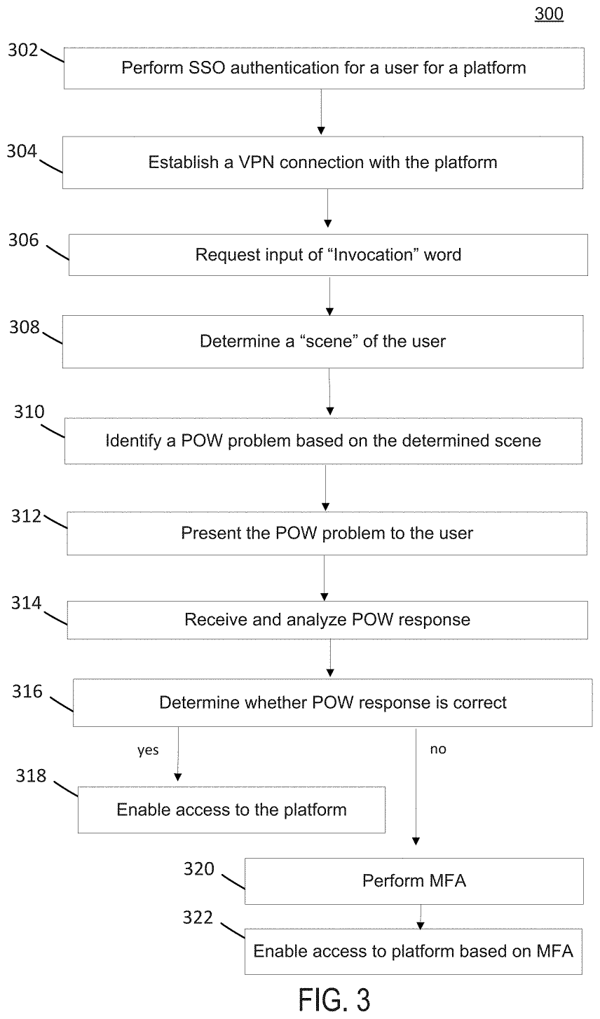

According to some embodiments, authentication engine 200 includes SSO/VPN module 202, pass-phrase module 204, AVA module 206 and MFA module 208, as illustrated in FIG. 2. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below in relation to FIG. 3.

FIG. 3 provides Process 300 which details non-limiting example embodiments of an authentication process for a user requesting access to a network resource (e.g., an enterprise platform, for example). According to some embodiments, Steps 302-304 of Process 300 can be performed by SSO/VPN module 202 of authentication engine 200; Steps 306-308 can be performed by pass-phrase module 204; Steps 310-318 can be performed by AVA module 206; and Steps 320-322 can be performed by MFA module 208.

Process 300 begins with Step 302 where SSO authentication for a user is performed. As discussed above, this can involve the user logging in to his/her device and/or another account, which can be associated with the user's device and/or a network resource. For example, unlocking the device by receiving a PIN or biometric input.

In Step 304, a VPN connection over a network (e.g., network 102) is established based on the SSO log-in from Step 302. The VPN connection by the user's device (e.g., UE 502) enables an encrypted virtual connection over network 104 which ensures the data communicated during the subsequent steps of Process 300 (e.g., steps related to Stages 2 and 3) are secure and protected. In some embodiments, the VPN connection enables a network connection with a desired resource (or platform). For example, if a user is desiring to login to his/her enterprise mail, a VPN connection can be established with that system (e.g., system 104) over a network (e.g., network 102), from which the POI and POW steps can be executed, as discussed below.

In Step 306, engine 200 can prompt the user for input of the invocation word, as discussed above. Such prompt can be an audible request or can be displayed on the user's device. As discussed above, the invocation word commences the 4way matching (Stage 2) of the authentication process. In some embodiments, in a case of a digital assistant using a voice channel, the user's device may be in a listening mode waiting for the user to speak an invocation word.

According to some embodiments, invocation words are key words from a multitude of predefined private lists of pass-phrases. Each list corresponds to a type of scene, as discussed herein. Invocation words are the initial terms in a predetermined sequence of terms that are alternatively spoken and/or output by the user and/or engine 200, respectively.

In Step 308, engine 200 determines the scene of the user. The processing operations by engine 200 for Step 308 involve the reception of the invocation word, the identification of the pass-phrase list for a particular scene (that includes the invocation word), then the iterative “request-receive” operation of audibly outputting and receiving pass-phrase terms from the user.

For example, turning now to FIG. 4, example 400 includes Scene 1, item 402 (discussed above); Scene 2, item 404; and Scene 3, item 406. Each scene can correspond to a type of operating environment/setting of the user. For example, Scene 1 can correspond to a list of pass-phrases to use in a public setting; Scene 2 can be used for semi-public settings, and Scene 3 can correspond to a private setting.

The notation of the 4way matching involves the 4 keys being shared between a user and engine 200. As depicted in FIG. 4, UK1 is a user provided key, and represents the invocation word. Sk1 is a system key (e.g., word or phrase) that is provided by engine 200 in response to receiving UK1. In some embodiments, Sk1 can be stored in a cloud NLP layer. Sk2 is a second system key (e.g., word or phrase) that is audibly output by engine 200. In some embodiments, Sk2 can be stored and retrieved from the platform that is being attempted to be accessed (e.g., an enterprise system). And, Uk2 is another user provided key that is spoken by the user in response to receiving (e.g., hearing) Sk2. Uk2 represents a “closing word” that concludes the 4way pass-phrase matching.

By way of a non-limiting example depicted as item 404, Scene 2, a user speaks “Snowy”. This is used by engine 200 to identify the list of terms “Snowy, winter, morning, shovel”. This also indicates to engine 200 that the scene, for example, is semi-public (e.g., a family setting). In response, engine 300 audibly outputs “winter”, then audibly outputs “morning”, whereby the user is expected to respond with “shovel”.

In another non-limiting example depicted as item 406, Scene 3, a user speaks or enters “Very”. This is used by engine 200 to identify the list of terms “Very, sunny, day, coke”. This also indicates to engine 200 that the scene, for example, is private (e.g., driving alone in a car). In response, engine 300 audibly outputs “sunny”, then audibly outputs “day”, whereby the user is expected to respond with or enter “coke”.

In some embodiments, if the user's closing word is not correct, MFA processing can be triggered and performed in a similar manner as discussed below in relation to Step 320. In some embodiments, in addition to or alternatively to MFA, the system can request another invocation word to perform the processing of Steps 306-308 again. In some embodiments, if the user fails the 4way matching and/or MFA a predetermined number of times, then the user's authentication request is denied. In some embodiments, the VPN connection is disconnected, yet the SSO login by the user can remain.

In some embodiments, when engine 200 receives the invocation word (in Step 306), engine 200 analyzes the stored set of pass-phrase lists, and identifies a list that begins with the invocation word. This also provides an indication of the type of scene. Engine 200 can then retrieve information that indicates the next three keys that are to be provided. In some embodiments, the information indicates the location for retrieval of Sk1 and Sk2. Upon receiving Uk2 (e.g., closing word), engine 200 confirms the POI of the user and the type of scene and proceeds to Step 310.

In some embodiments, the determination of a type of scene can also or alternatively be based a type of network the user is operating on or connected to, and/or the signal characteristics of that network. For example, if the user is connected to a public Wi-Fi network, then this can indicate the user is in a public or semi-public setting.

In some embodiments, the determination of a type of scene can also or alternatively be based on a derived (or determined) risk. In some embodiments, the derived risk can be determined by engine 200 based on the scene opted by the user (e.g., via the invocation word) and the data being requested access to. For example, if a user indicates that she is in a public setting, but wishes to access privileged information, this can indicate and/or result in a high risk to the privileged data. Therefore, a derived risk computation can be performed based on the type of scene the user is operating in and the type of data the user is requesting.

In some embodiments, the derived risk can be computed as following:

Derived Risk=(Vulnerability Score)×(Data Risk Score).

In some embodiments, according to a non-limiting example, Vulnerability Scores can correspond to a scene/setting of the user, and can be set as follows:

| Vulnerability Score | Measure |
|---|---|
| Low | 1 |
| Medium | 2 |
| High | 3 |
| Very High | 4 |

For example, a user's car (e.g., a private setting) may be “low”, and a user being at the airport terminal waiting to board a flight (e.g., a public setting) can be “very high.”

In some embodiments, according to a non-limiting example, a Data Risk Score can correspond to a type of data being requested, and can be set as follows:

| Data Risk Score | Measure |
|---|---|
| Low | 1 |
| Medium | 2 |
| High | 3 |
| Very High | 4 |

For example, access to a user's mail account can be a “high” risk, and access to a user's home page for a web portal (e.g., ESPN+) may be “low” risk.

In some embodiments, the computed derived risk can be compared against a risk threshold, and if it surpasses and/or satisfies the threshold, it can be indicated that the assumed risk to the data is too high, and a private scene is determined, for example.

Upon determining the scene of the user (e.g., where the user is), Process 300 proceeds to Step 310 where a POW problem is identified. In some embodiments, Step 310 can involve identifying a type of POW macro pattern based on the scene, from which a micro pattern included therein can be randomly selected by engine 200, as discussed above.

For example, if the scene is private, the POW macro problem can be a simple mathematical problem, where engine 200 randomly selects addition of decimals in a similar manner to Table 1 discussed above. In another example, if the scene is semi-public, then the POW macro problem can be an alpha pattern shifting manipulation similar to the example in Table 2 above. As discussed above, the POW problem includes a macro category depending on the complexity needed for the type of scene, and a randomly selected or generated pattern/value that the user must correctly answer/solve.

In Step 312, the POW problem is presented to the user, and in response to receiving the user's response, the user's answer/solution is analyzed, as in Step 314. In some embodiments, engine 200 can implement any type of known or to be known statistical or probability machine learning (ML) or AI machine or model to compute the accuracy of the response. As discussed above, Step 314 involves the analysis of whether the correct calculation and/or pattern shift was provided by the user. In Step 316, a determination is made by engine 200 regarding whether the POW response input by the user is correct. If it is, the Process 300 proceeds to Step 318 where the user is granted access to the platform.

If Step 316 indicates that that the user's response is not correct, then engine 200 can implement a MFA (or two-factor) processing, as in Step 320. For example, the system can send an email to an account of the user, provide and request a one-time password, and/or trigger any type of known or to be known MFA processing to verify the user's identity. Upon MFA verification in Step 320, Step 322 can be executed where the user is granted access to the platform.

In some embodiments, a predetermined number of POW problems (e.g., 3) can be presented to the user prior to proceeding to MFA processing in Step 320. In such embodiments, engine 200 can determine whether the user has failed to correctly provide a POW response a predetermined number of times before triggering the MFA module 208. In some embodiments, the type of MFA can be based on the type of scene of the user (from Step 308).

According to some embodiments, upon receiving a logout instruction/request from the user, access to the platform is ended, however, the user's SSO/VPN connection can be maintained. In some embodiments, the SSO can remain, whereby the VPN connection is severed, and must be reestablished via another SSO iteration in order to re-engage Stage's 2 and 3 of engine 200's processing.

FIG. 5 is a block diagram of an example network architecture according to some embodiments of the present disclosure. In the illustrated embodiment, UE 502 accesses a data network 508 via an access network 504 and a core network 506. In the illustrated embodiment, UE 502 comprises any computing device capable of communicating with the access network 504. As examples, UE 502 may include mobile phones, tablets, laptops, sensors, IoT devices, autonomous machines, and any other devices equipped with a cellular or wireless or wired transceiver. One example of a UE is provided in FIG. 6.

In the illustrated embodiment, the access network 504 comprises a network allowing over-the-air network communication with UE 502. In general, the access network 504 includes at least one base station that is communicatively coupled to the core network 506 and wirelessly coupled to zero or more UE 502.

In some embodiments, the access network 504 comprises a cellular access network, for example, a fifth-generation 5G network or a fourth-generation (4G) network. In one embodiment, the access network 504 and UE 502 comprise a NextGen Radio Access Network (NG-RAN). In an embodiment, the access network 504 includes a plurality of next Generation Node B (gNodeB) base stations connected to UE 502 via an air interface. In one embodiment, the air interface comprises a New Radio (NR) air interface. For example, in a 5G network, individual user devices can be communicatively coupled via an X2 interface.

In the illustrated embodiment, the access network 504 provides access to a core network 506 to the UE 502. In the illustrated embodiment, the core network may be owned and/or operated by a mobile network operator (MNO) and provides wireless connectivity to UE 502. In the illustrated embodiment, this connectivity may comprise voice and data services.

At a high-level, the core network 506 may include a user plane and a control plane. In one embodiment, the control plane comprises network elements and communications interfaces to allow for the management of user connections and sessions. By contrast, the user plane may comprise network elements and communications interfaces to transmit user data from UE 502 to elements of the core network 506 and to external network-attached elements in a data network 508 such as the Internet.

In the illustrated embodiment, the access network 504 and the core network 506 are operated by an MNO. However, in some embodiments, the networks (504, 506) may be operated by a private entity and may be closed to public traffic. For example, the components of the network 506 may be provided as a single device, and the access network 504 may comprise a small form-factor base station. In these embodiments, the operator of the device can simulate a cellular network, and UE 502 can connect to this network similar to connecting to a national or regional network.

In some embodiments, the access network 504, core network 506 and data network 508 can be configured as a multi-access edge computing (MEC) network, where MEC or edge nodes are embodied as each UE 502, and are situated at the edge of a cellular network, for example, in a cellular base station or equivalent location. In general, the MEC or edge nodes may comprise UEs that comprise any computing device capable of responding to network requests from another UE 502 (referred to generally as a client) and is not intended to be limited to a specific hardware or software configuration a device.

FIG. 6 is a block diagram illustrating a computing device showing an example of a client or server device used in the various embodiments of the disclosure.

The computing device 600 may include more or fewer components than those shown in FIG. 6, depending on the deployment or usage of the device 600. For example, a server computing device, such as a rack-mounted server, may not include audio interfaces 652, displays 654, keypads 656, illuminators 658, haptic interfaces 662, GPS receivers 664, or cameras/sensors 666. Some devices may include additional components not shown, such as graphics processing unit (GPU) devices, cryptographic co-processors, artificial intelligence (AI) accelerators, or other peripheral devices.

As shown in FIG. 6, the device 600 includes a central processing unit (CPU) 622 in communication with a mass memory 630 via a bus 624. The computing device 600 also includes one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal, or electromagnetic sensors 666. Device 600 can include one camera/sensor 666 or a plurality of cameras/sensors 666. The positioning of the camera(s)/sensor(s) 666 on the device 600 can change per device 600 model, per device 600 capabilities, and the like, or some combination thereof.

In some embodiments, the CPU 622 may comprise a general-purpose CPU. The CPU 622 may comprise a single-core or multiple-core CPU. The CPU 622 may comprise a system-on-a-chip (SoC) or a similar embedded system. In some embodiments, a GPU may be used in place of, or in combination with, a CPU 622. Mass memory 630 may comprise a dynamic random-access memory (DRAM) device, a static random-access memory device (SRAM), or a Flash (e.g., NAND Flash) memory device. In some embodiments, mass memory 630 may comprise a combination of such memory types. In one embodiment, the bus 624 may comprise a Peripheral Component Interconnect Express (PCIe) bus. In some embodiments, the bus 624 may comprise multiple busses instead of a single bus.

Mass memory 630 illustrates another example of computer storage media for the storage of information such as computer-readable instructions, data structures, program modules, or other data. Mass memory 630 stores a basic input/output system (“BIOS”) 640 for controlling the low-level operation of the computing device 600. The mass memory also stores an operating system 641 for controlling the operation of the computing device 600.

Applications 642 may include computer-executable instructions which, when executed by the computing device 600, perform any of the methods (or portions of the methods) described previously in the description of the preceding Figures. In some embodiments, the software or programs implementing the method embodiments can be read from a hard disk drive (not illustrated) and temporarily stored in RAM 632 by CPU 622. CPU 622 may then read the software or data from RAM 632, process them, and store them to RAM 632 again.

The computing device 600 may optionally communicate with a base station (not shown) or directly with another computing device. Network interface 650 is sometimes known as a transceiver, transceiving device, or network interface card (NIC).

The audio interface 652 produces and receives audio signals such as the sound of a human voice. For example, the audio interface 652 may be coupled to a speaker and microphone (not shown) to enable telecommunication with others or generate an audio acknowledgment for some action. Display 654 may be a liquid crystal display (LCD), gas plasma, light-emitting diode (LED), or any other type of display used with a computing device. Display 654 may also include a touch-sensitive screen arranged to receive input from an object such as a stylus or a digit from a human hand.

Keypad 656 may comprise any input device arranged to receive input from a user. Illuminator 658 may provide a status indication or provide light.

The computing device 600 also comprises an input/output interface 660 for communicating with external devices, using communication technologies, such as USB, infrared, Bluetooth™, or the like. The haptic interface 662 provides tactile feedback to a user of the client device.

The optional GPS transceiver 664 can determine the physical coordinates of the computing device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS, or the like, to further determine the physical location of the computing device 600 on the surface of the Earth. In one embodiment, however, the computing device 600 may communicate through other components, provide other information that may be employed to determine a physical location of the device, including, for example, a MAC address, IP address, or the like.

The present disclosure has been described with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure has been described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

To the extent the aforementioned implementations collect, store, or employ personal information of individuals, groups, or other entities, it should be understood that such information shall be used in accordance with all applicable laws concerning the protection of personal information. Additionally, the collection, storage, and use of such information can be subject to the consent of the individual to such activity, for example, through well known “opt-in” or “opt-out” processes as can be appropriate for the situation and type of information. Storage and use of personal information can be in an appropriately secure manner reflective of the type of information, for example, through various access control, encryption, and anonymization techniques (for especially sensitive information).

In the preceding specification, various example embodiments have been described with reference to the accompanying drawings. However, it will be evident that various modifications and changes may be made thereto, and additional embodiments may be implemented without departing from the broader scope of the disclosed embodiments as set forth in the claims that follow. The specification and drawings are accordingly to be regarded in an illustrative rather than restrictive sense.

What is claimed is:

1. A method comprising:
receiving, by a device, a set of words provided by a user, a portion of the received words being in response to a portion of a set of words provided by the device;
determining, by the device, a scene of the user based at least on a portion of the set of words received by the user, the scene indicating the current surroundings of the user;
identifying, by the device, a proof of work (POW) problem based on the determined scene;
presenting, by the device, the POW problem to the user;
receiving, by the device, a solution from the user to the POW problem;
analyzing, by the device, the solution, and determining, based on the analysis, whether access to a network resource is granted; and
enabling access, by the device over a network, to the network resource based on the access determination, wherein access is enabled when the solution is determined to be acceptable.

2. The method of claim 1, wherein receiving the set of words provided by the user comprises receiving an invocation word and a closing word, wherein the set of words output by the device comprise a first system word and a second system word.

3. The method of claim 2, further comprising:
receiving, by the device from the user, the invocation word;
outputting, by the device in response to the invocation word, the first system word;
outputting, by the device, after outputting the first system word, the second system word; and
receiving, by the device from the user, the closing word.

4. The method of claim 2, wherein the set of words provided by the user and the set of words provided by the device are associated with a predefined list of words, wherein the list is part of a collection of lists accessible over the network, wherein the list is identifiable by the invocation word.

5. The method of claim 4, wherein each list corresponds to a type of scene, wherein the type of scene is one of a public scene, semi-public scene and private scene.

6. The method of claim 1, wherein receiving the set of words provided by the user comprises audibly detecting spoken words by the user, wherein the set of words output by the device are audibly output by the device.

7. The method of claim 1, further comprising:
identifying, by the device, a type of POW problem based on the scene; and
randomly selecting, by the device, a specific POW problem from a set of POW problems of the identified type.

8. The method of claim 1, wherein the POW problem requests a calculation or manipulation by the user, wherein a value of the calculation or manipulation is preset by the user.

9. The method of claim 7, wherein the determination related to the solution is based on the value.

10. The method of claim 1, further comprising:
performing multi-factor authentication (MFA) processing when the solution is determined to be not acceptable, wherein access to the network resource is enabled when the MFA processing is successfully completed.

11. The method of claim 1, further comprising:
receiving a logout instruction from the user related to the network resource, wherein access to the device is maintained despite the user being logged out of the network resource.

12. The method of claim 1, wherein the enabled access to the network resource enables the user to perform create, read, update, delete (CRUD) operations in relation to data provided by the network resource.

13. The method of claim 1, further comprising:
performing single sign-on (SSO) on the device such that access to the device is based on the SSO; and
establishing a virtual private network (VPN) connection over the network based on the SSO.

14. The method of claim 1, wherein the network resource is an enterprise platform.

15. A device comprising:
a processor configured to:
receive a set of words provided by a user, a portion of the received words being in response to a portion of a set of words provided by the device;
determine a scene of the user based at least on a portion of the set of words received by the user, the scene indicating the current surroundings of the user;
identify a proof of work (POW) problem based on the determined scene;
present the POW problem to the user;
receive a solution from the user to the POW problem;
analyze the solution, and determine, based on the analysis, whether access to a network resource is granted; and
enable access, over a network, to the network resource based on the access determination, wherein access is enabled when the solution is determined to be acceptable.

16. The device of claim 15, wherein receiving the set of words provided by the user comprises receiving an invocation word and a closing word, wherein the set of words output by the device comprise a first system word and a second system word, wherein the processor is further configured to:
receive, from the user, the invocation word;
output, in response to the invocation word, the first system word;
output, after outputting the first system word, the second system word; and
receive, from the user, the closing word.

17. The device of claim 15, wherein the processor is further configured to:
identify a type of POW problem based on the scene; and
randomly select a specific POW problem from a set of POW problems of the identified type.

18. A non-transitory computer-readable medium tangibly encoded with instructions, that when executed by a processor of a device, perform a method comprising:
receiving, by the device, a set of words provided by a user, a portion of the received words being in response to a portion of a set of words provided by the device;
determining, by the device, a scene of the user based at least on a portion of the set of words received by the user, the scene indicating the current surroundings of the user;
identifying, by the device, a proof of work (POW) problem based on the determined scene;
presenting, by the device, the POW problem to the user;
receiving, by the device, a solution from the user to the POW problem;
analyzing, by the device, the solution, and determining, based on the analysis, whether access to a network resource is granted; and
enabling access, by the device over a network, to the network resource based on the access determination, wherein access is enabled when the solution is determined to be acceptable.

19. The non-transitory computer-readable medium tangibly of claim 18, wherein receiving the set of words provided by the user comprises receiving an invocation word and a closing word, wherein the set of words output by the device comprise a first system word and a second system word, wherein the method further comprises:
receiving, by the device from the user, the invocation word;
outputting, by the device in response to the invocation word, the first system word;
outputting, by the device, after outputting the first system word, the second system word; and
receiving, by the device from the user, the closing word.

20. The non-transitory computer-readable medium tangibly of claim 18, further comprising:
identifying, by the device, a type of POW problem based on the scene; and
randomly selecting, by the device, a specific POW problem from a set of POW problems of the identified type.
